(19) United States
(12) Patent Application Publication
(10) Pub. No.: US 2005/0047440 A1
(43) Pub. Date: Mar. 3, 2005

(54) Division of data structures for efficient simulation

(76) Inventors: Jerome Plun, Alexandria, VA (US); Alexey Shakula, Reston, VA (US)

Correspondence Address: ROBERT M. MCDERMOTT, ESQ., 1824 FEDERAL FARM ROAD, MONTROSS, VA, 22520, US

(21) Appl. No.: 10/914,602

(22) Filed: Aug. 9, 2004

Related U.S. Application Data
(60) Provisional application No. 60/497,689, filed on Aug. 25, 2003.

(51) Int. Cl. H04J 3/24

(52) U.S. Cl. 370/474; 370/389

(57) ABSTRACT

A system and method for modeling the replication of a packet uses a header that contains unique information relative to the replicated packet, and a pointer to the information that is common to the original packet. At each level of the protocol hierarchy, and particularly at the transmission layer, the unique information is contained in the header information that is added at that level, while the common information is the information in the protocol stack created prior to the appending of this header information. Only network elements that traverse and modify the contents of the prior protocol headers are fully instantiated, and thus the resources required for replicating packets is substantially reduced.

This application claims the benefit of U.S. Provisional Patent Application 60/497,689, filed 25 Aug. 2003.

### BACKGROUND AND SUMMARY OF THE INVENTION

This invention relates to the field of simulation systems, and in particular to a network simulator that includes models of wireless nodes or other forms of broadcast communications.

A network simulator is an analysis tool that provides information that is useful for network planning and evaluation. New or existing networks can be analyzed to determine network performance, identify communication bottlenecks, estimate throughput capacity, and so on. Proposed changes to networks can be evaluated via simulation before they are implemented, so that informed choices can be made among considered alternatives.

The simulation of a complex network consumes a substantial amount of computer resources. In a conventional network simulation, the transmission of a packet of information is simulated by the propagation of “events” from one node/element in the network to another. The generation of the packet at the source node is an event that is propagated to the first node along the communication path of this simulated packet. The arrival of this packet at the first node is an event that triggers the modeling of the propagation of this event through the first node, resulting in the generation of a subsequent transmission event from this node and a reception event at the next node along the communication path. This reception event triggers the modeling of the propagation of the event through the second node, and the subsequent transmission-reception events to the next node, and so on. To simulate actual network performance, the processing of an event at a node may trigger multiple events; for example, the simulation may include the estimation of an error likelihood at each node, and subsequent requests for retransmission from sending nodes based on the error likelihood.

The scheduling of each of these events and the modeling of the processing of each event through each node consumes computer time and memory, and if there are many simulated transmissions of packets and/or many nodes in each communication path, the simulation of a complex network can take hours, or days, to complete.

The simulation of a “broadcast” event, such as the transmission of a packet from a wireless device, or the transmission of a packet along a cable-TV network, further exacerbates the scheduling and modeling resource requirements of a network simulator. In a conventional point-to-point wired network, a transmission event from one node results in a single reception event at another node. In a wireless network, a transmission event from one node often results in the generation of a reception event at each of the nodes that are within range of transmitting node. In like manner, a transmission event from a cable-TV provider results in the generation of reception events at each receiving node.

FIG. 1 illustrates an example conventional data structure 100 of a transmission packet, using a hierarchical network protocol, commonly termed a “protocol stack”. In general, at the highest level of the hierarchy, an application program encapsulates the data 110 that is to be transmitted, and provides header information at the application level 120 that includes such parameters as the source and destination addresses and the size of the data content. At the next lower level of the hierarchy, the protocol layer, additional header information 130 is provided, including such parameters as source and destination IP addresses, packet sequence number, port address, quality-of-service (QOS) parameters, and the like. At the next-lower transmission layer, additional header information 140 is provided, such as the node addresses of the transmit-receiver pair on a current link along the path between the source and destinations at the protocol layer, measured signal to noise ratio on this link, and so on.

The “data” layer 110 of FIG. 1 is illustrated using a dashed line, indicating its optional inclusion in a network simulator, because a network simulator's lowest level of resolution is typically the packet level, and the simulation does not include the details associated with the propagation of each byte of each packet. Generally, a single “size” parameter is sufficient to indicate the number of bytes in the packet, without specifying the value of each of these bytes.

FIG. 2 illustrates an example simulation of broadcast transmissions of packets 201A from a node A in a wireless network. In the broadcast transmission illustrated in FIG. 2, each packet 201A has the conventional protocol stack structure as illustrated in FIG. 1. The transmission of each packet 201A to each of the different nodes B, C, and D has unique characteristics, based for example, on the different distances of the nodes B, C, and D from the transmitting node A. Thus, the received packets 201B, 201C, and 201D at nodes B, C, and D will differ from each other in one or more parameters, such as the time of arrival of the packet, the received signal strength of the packet, the noise level during reception of the packet, and so on.

Because the characteristics of the reception at each node B, C, and D within the range of node A may differ, based on the characteristics of each transmit-receive pair A-B, A-C, A-D, each packet 201A that is transmitted from node A results in a replication of the packet at each of the receiving nodes, as illustrated by receptions 201B, 201C, and 201D. In like manner, each of the transmitted packets from each of the other nodes B, C, and D are replicated at each of the nodes within the range of each node. The creation of each modified copy of the packet as it is propagated from source to destination can consume substantial computer time and resources, particularly if the packet is transmitted along a link that includes a broadcast from one node to multiple other nodes.

An objective of this invention is to provide an efficient method of simulating traffic in a network simulator. A further objective of this invention is to substantially reduce the storage requirements associated with the simulation of broadcast traffic in a network simulator. A further object of this invention is to substantially reduce the number of redundant copies of information associated with traffic in a network simulator.

These objectives, and others, are achieved by providing a system and method that models a replicated packet using a header that contains unique information relative to the replicated packet, and a pointer to the information that is common to the original packet. At each level of the protocol hierarchy, and particularly at the transmission layer, the unique information is contained in the header information that is added at that level, while the common information is the information in the protocol stack created prior to the appending of this header information. Only network elements that traverse and modify the contents of the prior protocol headers are fully instantiated, and thus the resources required for replicating packets is substantially reduced.

### BRIEF DESCRIPTION OF THE DRAWINGS

The invention is explained in further detail, and by way of example, with reference to the accompanying drawings wherein:

FIG. 1 illustrates an example packet comprising a conventional protocol stack.

FIG. 2 illustrates an example simulation of broadcast transmissions in a conventional simulator.

FIG. 3 illustrates an example simulation of broadcast transmissions in a simulator of this invention.

FIG. 4 illustrates an example flow diagram for replicating a broadcasted packet in accordance with this invention.

FIG. 5 illustrates an example flow diagram for processing a replicated packet in accordance with this invention.

FIG. 6 illustrates an example core of a network simulator in accordance with this invention.

Throughout the drawings, the same reference numerals indicate similar or corresponding features or functions. The drawings are included for illustrative purposes and are not intended to limit the scope of the invention.

### DETAILED DESCRIPTION OF THE INVENTION

The invention is presented using the paradigm of the simulation of a wireless network that includes the replication of packets that are broadcast transmitted from one node to multiple other nodes. This invention is particularly well suited for improving the efficiency of such a simulation, but is not limited to this application. One of ordinary skill in the art will recognize that the principles of this invention can be applied at all levels of the protocol hierarchy, but the greatest efficiency gains are realized at the lower levels of the hierarchy, and particularly at the transmission layer during the simulation of broadcast transmissions.

FIG. 3 illustrates an example simulation of broadcast transmissions of packets 301A in a simulator of this invention, corresponding to the simulation of broadcast transmissions of packets 201A in a conventional simulator as illustrated in FIG. 2. For convenience, the reference numerals of the prior art illustration of FIG. 2 are used to illustrate some of the principles of this invention.

In a preferred embodiment of this invention, the data structure used to model packets in the simulated network substantially conforms to the hierarchical protocol data structure of the packets being modeled. That is, for example, a packet that is simulated as being transmitted between nodes at the physical/transmission layer includes application layer information, protocol layer information, and transmission layer information. In accordance with this invention, the header information at each layer in the simulated packets includes information that is relevant to the simulation of the packet at the given protocol layer. For example, based on the specified distances between nodes and other parameters provided in the simulation, including the other traffic being simulated, and other factors, the estimated signal to noise ratio of a received packet can be calculated, and this information can be included in the header information that is created when the particular reception packet 201B, 201C, 201D is created. This information is simulator-specific, in that such information does not exist in the packet header of actual packets that are transmitted between nodes. Other simulation-specific and link-specific information may also be contained in the headers that are created in the simulator of this invention.

Because the unique simulator-specific characteristics associated with the simulation of each packet are contained in the header information associated with the protocol layer that produces these characteristics, the information contained in the packets at higher levels of the protocol stack is common to each of the replications 201B, 201C, and 201D of the transmitted packet 201A. In accordance with this invention, as illustrated in FIG. 3, a single copy of the common information 310 is maintained, and each replication 301B, 301C, and 301D of a transmitted packet 301A includes a pointer 311 to this common information. Each replication 301B, 301C, 301D also includes header information 320B, 320C, 320D that includes information that is unique to the transmission of the packet 301B, 301C, 301D to nodes B, C, and D, from node A.

In FIG. 3, the packets 301A from node A are also illustrated as containing a pointer 311 to the common information 310. One of ordinary skill in the art will recognize that the common information 310 may be contiguous with one of the unique headers 320A, 320B, 320C, or 320D, so that one of the pointers can be avoided. Typically, this contiguous structure will be provided at the transmitting node A, and each receiving node's packet 301B, 301C, 301D, will reference the common area of the transmitted packet 301A. One of ordinary skill in the art will also recognize that, because the transmitter-receiver specific information is contained in each of the header items 320B, 320C, and 320D relative to the transmission from node A to nodes B, C, and D, respectively, the header 320A, and, correspondingly, the packet 301A, may be unnecessary, provided that the common information 310 is available.

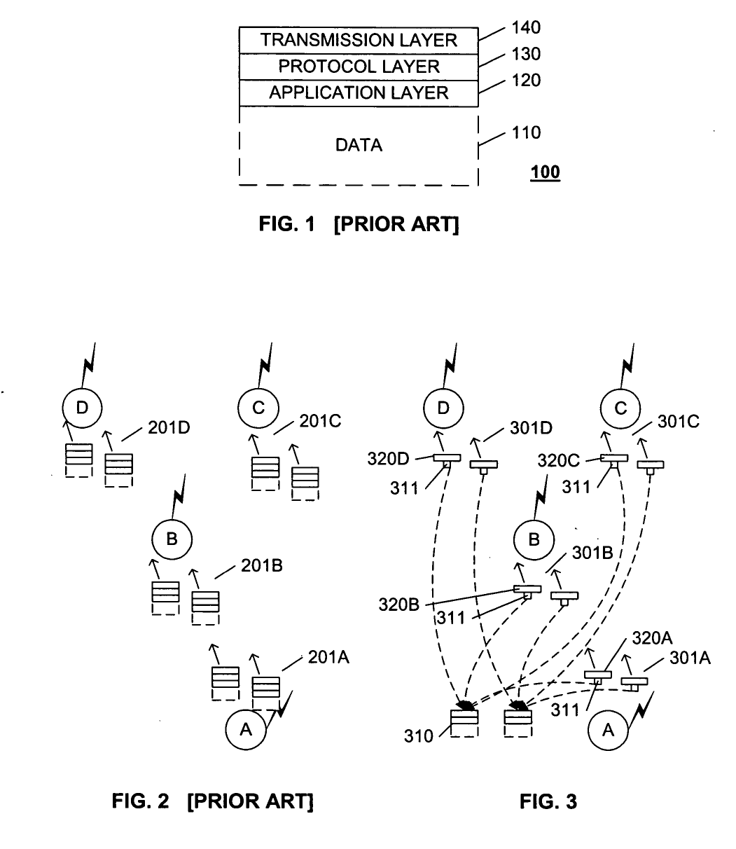

Because a single copy of the common information 310 is maintained, and each of the replicated packets merely contains a pointer 311 to this common information, substantial savings are achieved with respect to memory allocation. Further, because the replication of transmitted packets 301A only requires the creation of the header information 320B, 320C, 320D and the appending of the pointer 311, substantial processing gains are achieved, compared to copying the common information for each replicated packet. Other advantages of using a pointer 311 to common packet information 310 for replicating and propagating packets will be evident to one of ordinary skill in the art in view of this invention. It is noted that the advantages of this invention can be realized at each layer of the protocol hierarchy. That is, for example, with regard to FIG. 1, a simulation model of an element that creates the protocol layer in this invention can be configured to create a unique protocol header 130, and a pointer to the higher-layer packet comprising the application layer header 120 and the data 110, or a pointer to data 110. A typical example of such a higher-level protocol embodiment includes the simulation of multi-cast traffic, such as stock quotes, Internet video feeds, and so on from a common source. In such an embodiment, each recipient of the multi-cast traffic receives a unique protocol header 130, and a pointer to the common application layer header 120 and data 110.

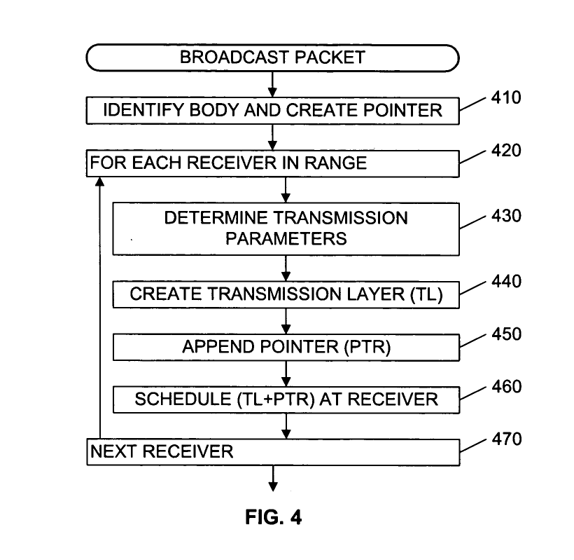

FIG. 4 illustrates an example flow diagram for replicating a broadcasted packet in accordance with this invention. In the following description, the reference numerals of FIG. 3 are presented, in parenthesized form, to facilitate ease of understanding. However, the flow of FIG. 4 is not limited to the example traffic flow of FIG. 3. For ease of reference and understanding, the information that is common to all replications of a packet at a given protocol layer is hereinafter termed the “body” of the message, and the collection of information that is unique to the protocol layer is termed the “header” of the message, at this level of the protocol hierarchy.

At 410, the body of the packet is identified and a reference pointer PTR to this body is created. The loop 420-470 is executed for each replication of the packet. In a simulation of a broadcast environment, the packet (301A) is replicated (301B, 301C, 301D) for each receiver (B, C, D) within range of a transmitting node (A), as discussed above. At 410, parameters specific to the transmission from node A and common to all of the receivers may also be determined, and stored in a transmission header (320A) associated with the transmitting node (A).

At 430, the parameters of the particular replication of the transmitted packet (301A) are determined, based on characteristics of the transmission path between the transmitting node (A) and the particular receiving node (B, C, or D).

At 440, the transmission layer header TL (320B, 320C, or 320D) is created to contain the parameters of the particular replication of the transmitted packet (301A). This header TL (320B, 320C, 320D) may include a copy of the transmission header (320A) associated with the transmitting node (A), and augmented to include the parameters specific to the particular transmit-receive pair (A-B, A-C, or A-D).

At 450, the pointer PTR to the body (311) is appended to the header TL (320B, 320C, or 320D), thereby forming the replication (301B, 301C, 301D) of the transmitted packet (301A) for each of the receivers (B, C, D). This replication is then scheduled to be received at the particular receiver (B, C, D) at a time that is determined based on the distance of each receiver from the transmitter, at 460.

By use of the flow diagram of FIG. 4, packets are replicated for transmission to each receiver, without requiring that the entire packet be replicated, thereby saving computer resources and processing time.

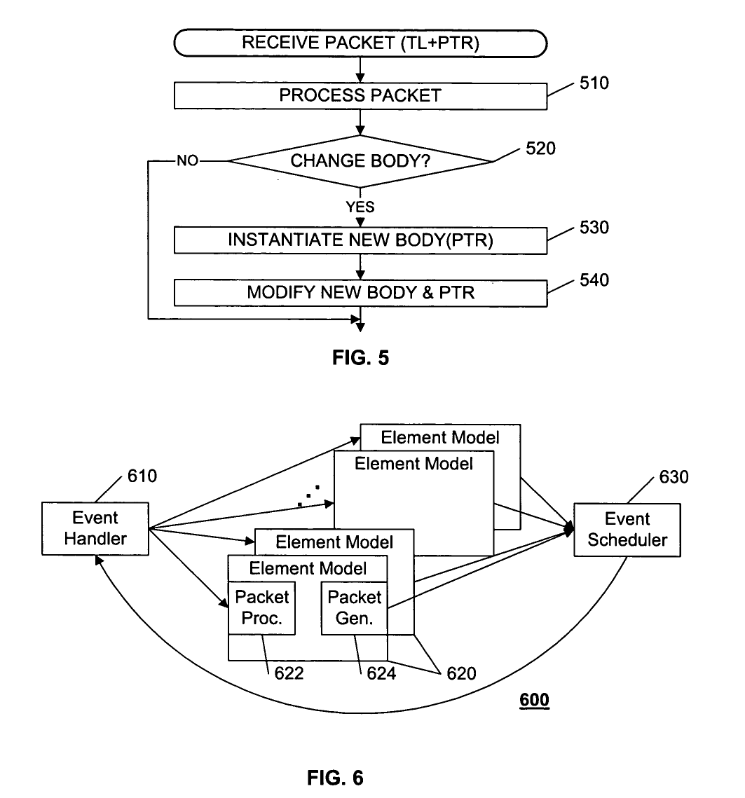

FIG. 5 illustrates a flow diagram corresponding to the simulation of a receipt of a replicated packet at a receiver. At 510, the packet is processed, using conventional simulation techniques. Because the transmitter-receiver specific information is contained in the aforementioned header TL (320B, 320C, 320D), the processing at a receiving node can generally occur without requiring access to the body of the packet. Received packets are one of three types: a packet that is not addressed to the receiving node, a packet that is addressed to the node as the terminal destination of the packet; a packet that is addressed to the node as an intermediate link to the terminal destination of the packet.

If the packet is not addressed to the receiving node, the processing of the packet typically involves nothing more than recognizing the address and discarding the packet. To do so, the processing routine does not need to access the body of the packet.

If the packet is addressed to the receiving node as the terminal destination, the processing of the packet will generally require access to the body of the packet. In such a case, the simulator accesses the body via the use of the referential pointer to the body, using techniques common to the art of computer programming. Upon completion of the processing, the packet is discarded.

To preserve memory space, a counter is preferably maintained for each body. At each replication of the packet that uses a pointer to this body, the count is incremented; at each discard of a packet that uses a pointer to the body, the count is decremented. When the count is zero, the referenced body can safely be deleted.

If the packet is addressed to the receiving node as an intermediate link to a terminal destination, one of two scenarios is possible. If the receiving node is merely acting as a “repeater”, it merely schedules a retransmission of the packet, using, for example, the flow diagram of FIG. 4. If, on the other hand, the receiving node is a router or gateway device that changes the protocol of the packet, the receiving node will typically progress up to the protocol layer and change or replace the information at that layer appropriately.

If, at 520, the body needs to be modified, due to the aforementioned protocol change, or other processing requirements, the body that is pointed to by the pointer PTR is instantiated as a new body, at 530. At 540, the pointer is modified to point at this new body, and this new body is modified as required.

The subsequent processing continues thereafter, using the packet that contains either the pointer to the received body (via the “NO” path from 520), or the pointer to the amended body (from 540).

Although the flow diagrams of FIGS. 4 and 5 are provided in the context of the transmission level of a broadcast transmission with multiple receptions, one of ordinary skill in the art will recognize that the use of a reference pointer to a body of generally static information and a header that contains generally dynamic information can be applied at each level of the protocol stack, and is not limited to a broadcast transmission to multiple receivers. That is, the techniques of this invention can be used in the conventional simulation of point-to-point transmissions, although the benefits of this invention are particularly apparent in the simulation of point-to-multipoint transmissions.

FIG. 6 illustrates an example core of a network simulator 600 in accordance with this invention. The core simulator 600 includes an event handler 610, a plurality of element models 620, and an event scheduler 630. One of ordinary skill in the art will recognize that other modules, such as a user interface module, an output module, and so on, are also contained in any network simulator, but, because such modules are substantially unaffected by the embodiment of this invention, they are not illustrated in FIG. 6, for ease of understanding. Also, the simulator 600 illustrates an event-driven simulator, although one of ordinary skill in the art will recognize that the principles of this invention are not limited to event-driven simulators.

The event handler 610 simulates the occurrences of events. Generally, as discussed further below, events are scheduled to occur at specific simulation times. The event handler 610 scans the schedule of events to determine which events are scheduled to occur at the current simulation time, and provides each scheduled event to the appropriate element model 620 associated with the event. For example, if the scheduled event at the current simulation time is the arrival of a given packet at a particular node, the event handler 610 provides the given packet to the element model 620 of the particular node, and in so doing, activates the element model 620 to process the given packet. In a conventional software embodiment, for example, the event handler 610 may call a subroutine corresponding to the element model 620, with an identification of the packet and node as arguments.

Each element model 620 processes the given event, and, in most cases, will generate one or more subsequent events based on this processing. These subsequent events are provided to the event scheduler 630. The event scheduler 630 collects and organizes the appropriate information to facilitate the above described simulation of the event by the event handler 610 and element models 620, when the event is scheduled to occur.

As illustrated in FIG. 6, an example element model 620 includes a packet processor 622 and a packet generator 624. In a conventional point-to-point network simulator, the packet processor 622 receives a packet at the packet processor 622, and, at some later point in time, transmits a packet from the packet generator 624. Depending upon the structure of the simulator, the transmission of the packet through a medium from one node to another node may be modeled within the element model 620 of the transmitting node, so that the output event from the transmitting element model 620 is the scheduled arrival of the transmitted packet at the receiving element. Alternatively, a separate element model 620 may be used to model the transmission medium, so that the output event from the transmitting element model 620 is the scheduled transmission time of the transmitted packet into the transmission medium, and the resultant output from the element model 620 of the transmission medium is the scheduled arrival of the transmitted packet at the receiving element.

In the network simulator of this invention, the packet generator 624 is configured to provide multiple output events corresponding to the scheduled arrival of the broadcast packet at each receiving element. As in the conventional point-to-point simulator, this packet generator 624 may be contained within the model of each broadcast transmitter, or within a model of the medium between the broadcast transmitter and the multiple receivers.

In accordance with this invention, the packet generator 624 is configured to generate header information that is specific to each receiver of the broadcast transmission, and to append to this header information a pointer to the body of the packet that is common to all the receivers of the packet, using, for example, the flow diagram of FIG. 4. In like manner, the packet processor 622 is configured to receive and process such formatted packets, using, for example, the flow diagram of FIG. 5.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the simulator 600 is presented above using an explicit event scheduler and an event handler. One of ordinary skill in the art will recognize that the scheduling and handling functions may be distributed throughout the simulator 600, and not necessarily embodied as discrete elements. For example, in an object-oriented embodiment of this invention, the element models 620 be objects that receive a parameter that specifies their next scheduled activation time, and are autonomously activated when the simulation time equals this scheduled activation time. These and other system configuration and optimization features will be evident to one of ordinary skill in the art in view of this disclosure, and are included within the scope of the following claims.

In interpreting these claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) each of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise; and
h) no specific sequence of acts is intended to be required unless specifically indicated.

1. A method of simulating a network, comprising:
creating a packet of information comprising a header section and a body section,
creating a pointer to the body section,
propagating a copy of the packet of information to a receiving node by forwarding a copy of the header section and a copy of the pointer to the receiving node.

2. The method of claim 1, wherein
creating the packet occurs at a given level of a protocol hierarchy, and
the header section comprises information that is specific to the given layer of the protocol hierarchy, and
the body section comprises information that is common to an upper layer of the protocol hierarchy.

3. The method of claim 1, further including
receiving the body section from another node in the network.

4. The method of claim 1, further including
receiving an other pointer to an other body section from another node in the network,
wherein
creating the body section includes instantiating a copy of the other body section, based on the other pointer, and
creating the pointer includes setting the pointer to point to the copy of the other body section.

5. The method of claim 4, further including
modifying the copy of the other body section.

6. A method of simulating a transmission of a packet from a transmitter to a plurality of receivers, including:
identifying a body section of the packet that contains information that is common to the plurality of receivers,
creating a header section corresponding to each receiver of the plurality of receivers, and
propagating the corresponding header section and a pointer to the body section to each receiver,
wherein
the header section of at least one receiver differs from the header section of at least one other receiver.

7. The method of claim 6, wherein
the header section corresponding to each receiver includes information that is dependent upon one or more characteristics associated with a transmission path between the transmitter and the receiver.

8. The method of claim 7, wherein
the one or more characteristics include at least one of:
a distance between the transmitter and the receiver,
a noise factor associated with the transmission path, and
a transmit power associated with the transmitter.

9. The method of claim 7, wherein
propagating the corresponding header and pointer to each receiver includes scheduling a reception of the corresponding header and pointer at the receiver at a subsequent time that is based on at least one of the one or more characteristics.

10. The method of claim 6, wherein
propagating the corresponding header and pointer to each receiver includes scheduling a reception of the corresponding header and pointer at the receiver at a subsequent time that is based on at one or more characteristics associated with a transmission path between the transmitter and the receiver.

11. The method of claim 6, wherein
the header section comprises information that is specific to a transmission layer of a protocol hierarchy, and
the body section comprises information that is common to an upper layer of the protocol hierarchy.

12. The method of claim 6, further including
receiving the body section at the transmitter from another node in the network.

13. The method of claim 6, further including
receiving an other pointer to an other body section from another node in the network,
wherein
creating the body section includes creating a copy of the other body section, based on the other pointer, and
the pointer is configured to point to the copy of the other body section.

14. The method of claim 13, further including
modifying the copy of the other body section.

15. A network simulator comprising:
a plurality of element models that are configured to model elements of a network,
wherein
at least one of the element models includes
a packet generator that is configured to generate a plurality of packets,
each packet of the plurality of packets being associated with an intended receiver of the packet and comprising:
a header that includes information that is specific to the intended receiver, and
a pointer to a body of other information that is common to the plurality of packets.

16. The simulator of claim 15, wherein
the header includes information that is dependent upon one or more characteristics associated with a transmission path between a transmitter and the intended receiver.

17. The simulator of claim 16, wherein
the one or more characteristics include at least one of:
a distance between the transmitter and the intended receiver,
a noise factor associated with the transmission path, and
a transmit power associated with the transmitter.

18. The simulator of claim 15, further including
an event scheduler that is configured to schedule a reception of the corresponding header and pointer at each intended receiver at a subsequent time that is based on at one or more characteristics associated with a transmission path between a transmitter and the intended receiver.

19. The simulator of claim 15, wherein
the at least one element model also includes
a packet processor that is configured to:
receive an other packet from an other element model, and
provide the pointer to the body of other information, based on the other packet from the other element model.

20. The simulator of claim 19, wherein
the other packet includes an other pointer to an other body section, and
the packet processor is further configured to create a copy of the other body section, based on the other pointer, and
the pointer is configured to point to the copy of the other body section.

21. The simulator of claim 20, wherein
the packet processor is further configured to modify the copy of the other body section.
